(19) United States
(12) Patent Application Publication
(10) Pub. No.: US 2008/0021186 A1
(43) Pub. Date: Jan. 24, 2008

(54) Dimensionally stable adhesive and its use for glue sticks

(75) Inventor: Christian Steib, Steppach (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 11/879,247

(22) Filed: Jul. 17, 2007

(30) Foreign Application Priority Data
Jul. 18, 2006 (DE) 10 2006 033 148.6

(51) Int. Cl. C08F 10/00

(52) U.S. Cl. 526/348.3; 526/348; 526/348.2; 526/348.6

(57) ABSTRACT

A dimensionally stable adhesive can be applied at room or ambient temperature to substrate surfaces. It comprises at least one, or two or more, polyfin(s) prepared in the presence of metallocene catalyst and having a ring & ball softening point in the range from 50 to 165° C., a needle penetration number of <50×0.1 mm, and a melt viscosity, measured at a temperature of 170° C., in the range from 20 to 40 000 mPa·s. The adhesive is water- and solvent-free and is used as a glue stick in the form of sticks, blocks, figures, spheres or cones.

The present invention is described in the German priority application No. 10 2006 033 148.6, filed Jul. 18, 2006, which is hereby incorporated by reference as is fully disclosed herein.

The invention relates to a dimensionally stable adhesive which can be applied at room or ambient temperature and comprises at least one polyolefin, and to the use of the adhesive in glue sticks.

On account of their greater ease of use as compared with adhesives in liquid or paste form, glue sticks find widespread application particularly in the household or in offices, for the bonding of paper, card, photos, textiles, labels, etc. On account of their composition they present an economic and eco-friendly alternative to reactive adhesives or solvent-containing adhesives.

Conventional glue sticks contain pasty or gellike adhesives, mostly on an aqueous basis, but may also additionally include solvent (cf., e.g., Kleben-Grundlagen, Technologien, Anwendungen, Springer Verlag, 4th ed. 2002). For the purposes of shaping and handling, the adhesive is introduced as a displaceably mounted stick, similar to a lipstick, into a solid case. DE 35 00 283 describes glue sticks, for example, which as adhesives may comprise polyvinyl alcohol, dextrin, water-soluble cellulose ethers and/or polyvinylpyrrolidone. An adhesive described in EP 0 278 297 is a combination of natural rubber and tackifying resins. The sticks are generally shaped, and their consistency adjusted, by using aqueous soap gels. Alternatively to these, reaction products of sorbitol and benzaldehyde (DE 22 04 482), or terephthalamide derivatives (DE 26 20 721) or polyurethanes, have also been described. Bond strength and water resistance can be tailored through further additions such as melamine-formaldehyde resins or urea-formaldehyde resins. In glue stick application, a stable adhesive assembly arises out of the adhesive film after the water and/or solvent have evaporated.

One of the disadvantages of all known glue sticks is the soft, pasty consistency of the adhesive, which as such cannot easily be applied directly to the substrate on which bonding is to take place, and which therefore requires an additional, containing case with a specific dispensing function. The constitution of the case and the introduction of the adhesive into it make the production of conventional glue sticks inconvenient and expensive. In the course of application of the glue sticks it is found that the adhesives have a tendency to smear and in some cases also exhibit stringing. Furthermore, the use of the known glue sticks is confined to adequately vapor-permeable substrates such as paper or card, since for the adhesive layer to set it is necessary for the water and/or solvent present to be able to emerge from the adhesive layer and evaporate. A further disadvantage of known glue sticks is that they dry out easily if the case is not given a proper airtight closure, and then lose their adhesiveness completely.

The use of polyolefins, including those prepared in the presence of metallocene catalysts, as a formulating ingredient for adhesives is known (see, e.g., EP-A-1 631 641). To date, however, adhesives of this kind have found application exclusively as hotmelts; in other words, application takes place in the liquid melt state at an appropriately high temperature. Glue sticks, in contrast, are typically employed at room or ambient temperature.

It was an object of the present invention to provide a dimensionally stable adhesive which, without heating or melting, can be applied at room temperature in a simple way to surfaces and so leads to durable adhesive bonds by pressing of the surfaces together. The dimensionally stable adhesive ought to have a solid consistency and ought to be able to be handled without case materials. Furthermore, it is to be free of solvent, arbitrarily shapable, toxicologically and environmentally unobjectionable, and exhibit effective storage stability over a prolonged time period.

Surprisingly it has now been found that this object is achieved by means of an adhesive of the generic type specified at the outset, whose characterizing feature is seen in that the adhesive comprises at least one polyolefin prepared in the presence of metallocene catalysts and having a drop point or ring & ball softening point of between 50 and 165° C., a needle penetration of <50×0.1 mm, and a melt viscosity, measured at a temperature of 170° C., in the range from 20 to 40 000 mPa·s, preferably from 50 to 30 000 mPa·s, more preferably from 10 to 20 000 mPa·s.

With particular advantage the adhesive of the invention is a suitable alternative to adhesives conventionally used for glue sticks, since it possesses a sufficient mechanical strength and dimensional stability to be used without a containing case, in the same way as an eraser, but for adhesive purposes. The adhesive of the invention shows no tendency to smear and also does not exhibit stringing, but has outstanding properties in respect of its adhesion to the relevant substrates.

A further advantage of the adhesive of the invention is that it can also be used for bonding vapor-impermeable substrates such as polymeric films or metal foils and the like, since it contains neither water nor solvent.

The adhesive of the invention is solid at room temperature and remains dimensionally stable at temperatures up to at least 60° C. It is also storage-stable and cannot dry out. It has a color from light to colorless, is opaque to transparent, and is odor-neutral, nonbrittle, lightfast, and water-insensitive.

With particular preference in accordance with the invention the adhesive is water- and solvent-free.

Of further preference in accordance with the invention is an adhesive comprising at least one polyolefin having a drop point or ring & ball softening point in the range from 60 to 165°, preferably from 70 to 150° C., more preferably from 80 to 140° C.

The invention further provides an adhesive which comprises the above-specified polyolefin that possesses a number-average molar mass Mₙ in the range from 500 to 20 000 g/mol, preferably from 800 to 10 000 g/mol, and more preferably from 1000 to 5000 g/mol, and a weight-average molar mass M_{w} in the range from 1000 to 40 000 g/mol, preferably from 1600 to 30 000 g/mol, and more preferably from 2000 to 20 000 g/mol.

In a similarly preferred embodiment of the invention the polyolefin present in the adhesive is a homopolymer of propylene or of higher 1-olefins or an olefin copolymer comprising propylene and/or higher 1-olefins and also, where appropriate, ethylene. Higher 1-olefins used are preferably linear or branched olefins having 4 to 20 carbon atoms, preferably having 4 to 6 carbon atoms. These olefins may exhibit aromatic substitution in conjugation with the olefinically double bond. Examples of possible 1-olefins include 1-butene, 1-hexene, 1-octene or 1-octadecene and also styrene. The copolymers are composed preferably of 70% to 99.9% and more preferably of 80% to 99% by weight of one kind of olefin.

In one preferred embodiment of the invention the polyolefin present in the adhesive is a copolymer of propylene with at least one, or two or more, further monomer(s) selected from ethylene and linear or branched 1-olefins having 4 to 20 carbon atoms, preferably having 4 to 10 carbon atoms, the amount of structural units originating from propylene being preferably 70% to 99.9%, more preferably 80% to 99% by weight.

In a further embodiment the polyolefin present in the adhesive is a copolymer of ethylene and at least one branched or unbranched 1-olefin having 3 to 20 carbon atoms, the amount of structural units originating from ethylene being 70% to 99.9% by weight.

In a further preferred embodiment of the invention the polyolefin present in the adhesive is a copolymer of propylene and one or more further monomers selected from ethylene and/or branched or unbranched 1-olefins having 4 to 20 carbon atoms, the amount of structural units originating from ethylene in the copolymers being from 0.1% to 30% by weight and the amount of structural units originating from 1-alkene(s) in the copolymers being in the range from 0.1% to 50% by weight.

In one particularly preferred embodiment of the invention the polyolefin present in the adhesive is a copolymer of propylene with 0.1% to 30%, in particular with 1% to 20% by weight of ethylene.

The polyolefin used in the adhesive of the invention is present therein preferably in an amount of 2% by weight to 100% by weight, more preferably of 30% to 90% by weight, with particular preference of 40% to 70% by weight, and with very particular preference of 50% to 60% by weight, based in each case on the total weight of the adhesive.

In another preferred embodiment of the invention the adhesive, further to the polyolefin(s), comprises one or more polar-modified olefin homopolymers and/or copolymers.

Polar-modified polymers are prepared in a known way from apolar polymers by oxidation with oxygenous gases, such as with air, or by free-radical grafting reaction with polar monomers, such as with α,β-unsaturated carboxylic acids or their derivatives, such as acrylic acid, maleic acid or maleic anhydride, or with unsaturated organosilane compounds such as trialkoxyvinylsilanes. The polar modification of metallocene polyolefins by air oxidation is as such prior art and is described for example in EP 0 890 583; the grafting modification is described for example in EP 0 941 257.

The polar-modified olefin homopolymers and/or copolymers employed in accordance with the invention have number-average molar masses Mₙ of between 500 and 20 000 g/mol, preferably between 800 and 10 000 g/mol, and more preferably between 1000 and 3000 g/mol.

The polar-modified olefin homopolymers and/or copolymers are used in the adhesive of the invention in amounts of 0% to 10% by weight, preferably of 1% to 8% by weight, more preferably of 2% to 7% by weight, based on the amount by weight of polyolefin(s) employed.

As its adhesive component the adhesive of the invention may comprise one or more resins. Examples of resins available include typical so-called aliphatic and cycloaliphatic or aromatic hydrocarbon resins. These resins can be prepared by polymerizing certain resin oil fractions obtained in the processing of petroleum. Such resins, which can be modified by means for example of hydrogenation or functionalization, are available under the trade names ®Eastoflex, ®RegalREZ, ®kristalex, ®Eastotac, ®Piccotac (Eastman Chemical Company) or ®Escorez (ExxonMobil Chemical Company), for example.

Resins suitable in accordance with the invention further include polyterpene resins prepared by polymerizing terpenes, pinene for example, in the presence of Friedel-Crafts catalysts, and also hydrogenated polyterpenes, copolymers and terpolymers of natural terpenes, examples being styrene/terpene or a-methylstyrene/terpene copolymers. Also suitable are natural and modified rosins, especially resin esters, glycerol esters of wood resins, pentaerythritol esters of wood resins and tall oil resins, and their hydrogenated derivatives, and also phenol-modified pentaerythritol esters of resins, and phenol-modified terpene resins.

The stated resins may be present in the adhesive of the invention individually or in any desired combination, in amounts by weight, based on the total weight of the adhesive, of 0% to 60% by weight, preferably of 10% to 50% by weight, more preferably of 20% to 40% by weight.

One adhesive particularly preferred in accordance with the invention comprises
a) one or more polyolefins prepared in the presence of metallocene catalyst
b) one or more resinous adhesive components
c) one or more plasticizers.

Suitable plasticizers include liquid paraffins or other hydrocarbons. Also possible are aromatic or aliphatic dicarboxylic esters, examples being phthalic esters or adipic esters. Use may also be made of predominantly or wholly amorphous copolymers, such as those of branched or unbranched 1-olefins such as propylene, 1-butene, etc., optionally with ethylene. Polyolefins of this kind, which at room temperature are generally liquid and more or less viscous, can be prepared, for example, using Ziegler catalysts or metallocene catalysts. Examples of copolymers of this kind prepared with metallocene catalysts are described in EP 0 200 351, EP 0 586 777 or EP 1 554 320.

The plasticizers are used in the adhesive of the invention in amounts of 0% to 10% by weight, preferably 1% to 8% by weight, more preferably of 2% to 7% by weight, based in each case on the amount by weight of polyolefin(s) used.

A likewise particularly preferred subject of this invention is a dimensionally stable adhesive which can be applied at room or ambient temperature, without melting, to suitable substrate surfaces, and is composed of
a) one or more polyolefins prepared in the presence of metallocene catalyst
b) if desired, one or more polar-modified olefin homopolymers and/or copolymers
c) if desired, one or more adhesive components
d) if desired, one or more plasticizers.

In particularly advantageous embodiments the adhesive of the invention further comprises colorants such as dyes and pigments.

Suitable colorants include, in principle, organic or inorganic pigments or dyes. Typical examples are organic pigments from the class of the perylene, perinone, quinacridone, quinacridonequinone, anthraquinone, anthanthrone, benzimidazolone, disazo, azo, indanthrone, phthalocyanine, triarylcarbonium, dioxazine, such as triphendioxazine, aminoanthraquinone, diketopyrrolopyrrole, indigo, thioindigo, thiazineindigo, isoindoline, isoindolinone, pyranthrone, isoviolanthrone, flavanthrone, anthrapyrimidine or carbon black pigments and also mixed crystals or mixtures thereof.

Further examples are inorganic pigments from the class of titaniuim dioxide, zinc sulfide, zinc oxide, iron oxide, chromium oxide, mixed metal oxide (such as nickel rutile yellow, chromium rutile yellow, cobalt blue, cobalt green, zinc iron brown, (spinel black), cadmium, bismuth, chromate, ultramarine, and iron blue pigments and mixtures thereof, but also, equally, mixtures of organic and inorganic pigments.

Likewise suitable are natural dyes, examples being indigo, saffron, carmine, carminic acid, cochineal, curcumin, riboflavin, riboflavin-5′-phosphate, chlorophylls, carotenes, β-apo-8-carotenal, ethyl carotenate, lycopene, capsanthin, capsorubin, anthocyans, and beetroot red.

Particular preference is given to fat-soluble and oil-soluble dyes, particularly azo dyes.

The metallocene polyolefins used in accordance with the invention are prepared using metallocene compounds of the formula I.

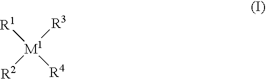

This formula also encompasses compounds of the formula Ia,

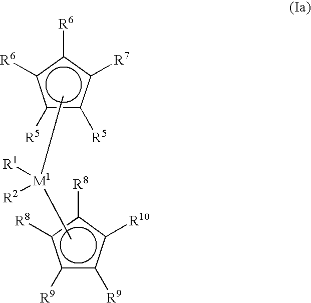

of the formula Ib,

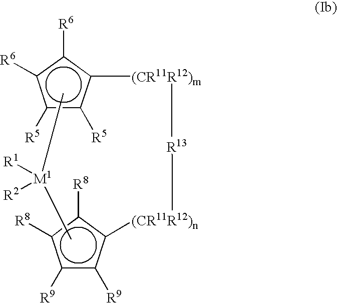

and of the formula Ic

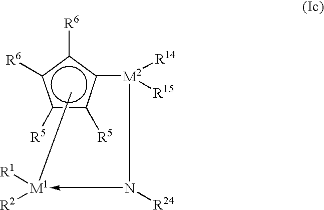

In the formulae I, Ia, and Ib M¹ is a metal of group IVb, Vb or VIb of the Periodic Table of the Elements, such as titanium, zirconium, hafnium, vanadium, niobium, tantalum, chromium, molybdenum or tungsten, for example, preferably titanium, zirconium, and hafnium.

R¹ and R² are alike or different and denote a hydrogen atom, a C₁-C₁₀, preferably C₁-C₃, alkyl group, particularly methyl, a C₁-C₁₀, preferably C₁-C₃, alkoxy group, a C₆-C₁₀, preferably C₆-C₈, aryl group, a C₆-C₁₀, preferably C₆-C₈, aryloxy group, a C₂-C₁₀, preferably C₂-C₄, alkenyl group, a C₇-C₄₀, preferably C₇-C₁₀, arylalkyl group, a C₇-C₄₀, preferably C₇-C₁₂, alkylaryl group, a C₈-C₄₀, preferably C₈-C₁₂, arylalkenyl group, or a halogen atom, preferably chlorine atom.

R³ and R⁴ are alike or different and denote a mononuclear or polynuclear hydrocarbon radical which with the central atom M¹ may form a sandwich structure. Preferably R³ and R⁴ are cyclopentadienyl, indenyl, tetrahydroindenyl, benzoindenyl or fluorenyl, it also being possible for the parent structures to carry additional substituents or to be bridged with one another. Moreover, one of the radicals R³ and R⁴ may be a substituted nitrogen atom, with R²⁴ having the definition of R¹⁷ and being preferably methyl, tert-butyl or cyclohexyl.

R⁵, R⁶, R⁷, R⁸, R⁹ and R¹⁰ are alike or different and denote a hydrogen atom, a halogen atom, preferably a fluorine, chlorine or bromine atom, a C₁-C₁₀, preferably C₁-C₄, alkyl group, a C₆-C₁₀, preferably C₆-C₈, aryl group, a C₁-C₁₀, preferably C₁-C₃, alkoxy group, a radical —NR¹⁶₂—, —SR¹⁶—, —OSiR¹⁶₃—, —SiR¹⁶₃— or —PR¹⁶₂, in which R¹⁶ is a C₁-C₁₀, preferably C₁-C₃, alkyl group or C₆-C₁₀, preferably C₆-C₈, aryl group or else, in the case of radicals containing Si or P, is a halogen atom, preferably chlorine atom, or pairs of adjacent radicals R⁵, R⁶, R⁷, R⁸, R⁹ or R¹⁰ form a ring with the carbon atoms connecting them. Particularly preferred ligands are substituted compounds of the parent structures cyclopentadienyl, indenyl, tetrahydroindenyl, benzoindenyl or fluorenyl.

### R¹³ is

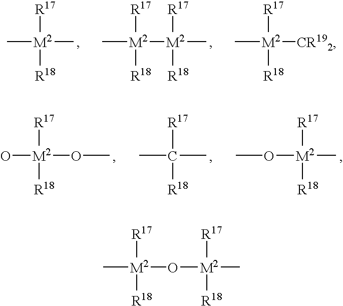

═BR¹⁷, ═AlR¹⁷, —Ge—, —Sn—, —O—, —S—, ═SO, ═SO₂, ═NR¹⁷, ═CO, ═PR¹⁷ or ═P(O)R¹⁷, where R¹⁷, R¹⁸, and R¹⁹ are alike or different and denote a hydrogen atom, a halogen atom, preferably a fluorine, chlorine or bromine atom, a C₁-C₃₀, preferably C₁-C₄, alkyl group, especially methyl group, a C₁-C₁₀fluoroalkyl, preferably CF₃ group, a C₆-C₁₀ fluoroaryl, preferably pentafluorophenyl group, a C₆-C₁₀, preferably C₆-C₈, aryl group, a C₁-C₁₀, preferably C₁-C₄ alkoxy group, especially methoxy group, a C₂-C₁₀, preferably C₂-C₄, alkenyl group, a C₇-C₄₀, preferably C₇-C₁₀, aralkyl group, a C₈-C₄₀, preferably C₈-C₁₂, arylalkenyl group or a C₇-C₄₀, preferably C₇-C₁₂, alkylaryl group, or R¹⁷ and R¹⁸, or R¹⁷ and R¹⁹, in each case form a ring together with the atoms connecting them.

M² is silicon, germanium or tin, preferably silicon and germanium. R¹³ is preferably ═CR⁷R⁸, ═SiR¹⁷R¹⁸, ═GeR¹⁷R¹⁸, —O—, —S—, ═SO, ═PR¹⁷ or ═P(O)R¹⁷.

R¹¹ and R¹² are alike or different and have the definition stated for R¹⁷. m and n are alike of different and denote zero, 1 or 2, preferably zero or 1, with m plus n being zero, 1 or 2, preferably zero or 1.

R¹⁴ and R¹⁵ have the definition of R¹⁷ and R¹⁸.

Preferred examples of suitable metallocenes are as follows:
bis(1,2,3-trimethylcyclopentadienyl)zirconium dichloride,
bis(1,2,4-trimethylcyclopentadienyl)zirconium dichloride,
bis(1,2-dimethylcyclopentadienyl)zirconium dichloride,
bis(1,3-dimethylcyclopentadienyl)zirconium dichloride,
bis(1-methylindenyl)zirconium dichloride,
bis(1-n-butyl-3-methylcyclopentadienyl)zirconium dichloride,
bis(2-methyl-4,6-diisopropylindenyl)zirconium dichloride,
bis(2-methylindenyl)zirconium dichloride,
bis(4-methylindenyl)zirconium dichloride,
bis(5-methylindenyl)zirconium dichloride,
bis(alkylcyclopentadienyl)zirconium dichloride,
bis(alkylindenyl)zirconium dichloride,
bis(cyclopentadienyl)zirconium dichloride,
bis(indenyl)zirconium dichloride,
bis(methylcyclopentadienyl)zirconium dichloride,
bis(n-butylcyclopentadienyl)zirconium dichloride,
bis(octadecylcyclopentadienyl)zirconium dichloride,
bis(pentamethylcyclopentadienyl)zirconium dichloride,
bis(trimethylsilylcyclopentadienyl)zirconium dichloride,
biscyclopentadienylzirconium dibenzyl,
biscyclopentadienylzirconium dimethyl,
bistetrahydroindenylzirconium dichloride,
dimethylsilyl-9-fluorenylcyclopentadienylzirconium dichloride,
dimethylsilylbis-1-(2,3,5-trimethylcyclopentadienyl)zirconium dichloride,
dimethylsilylbis-1-(2,4-dimethylcyclopentadienyl)zirconium dichloride,
dimethylsilylbis-1-(2-methyl-4,5-benzoindenyl)zirconium dichloride,
dimethylsilylbis-1-(2-methyl-4-ethylindenyl)zirconium dichloride,
dimethylsilylbis-1-(2-methyl-4-isopropylindenyl)zirconium dichloride,
dimethylsilylbis-1-(2-methyl-4-phenylindenyl)zirconium dichloride,
dimethylsilylbis-1-(2-methylindenyl)zirconium dichloride,
dimethylsilylbis-1-(2-methyltetrahydroindenyl)zirconium dichloride,
dimethylsilylbis-1-indenylzirconium dichloride,
dimethylsilylbis-1-indenylzirconiumdimethyl,
dimethylsilylbis-1-tetrahydroindenylzirconium dichloride,
diphenylmethylene-9-fluorenylcyclopentadienylzirconium dichloride,
diphenylsilylbis-1-indenylzirconium dichloride,
ethylenebis-1-(2-methyl-4,5-benzoindenyl)zirconium dichioride,
ethylenebis-1-(2-methyl-4-phenylindenyl)zirconium dichloride,
ethylenebis-1-(2-methyltetrahydroindenyl)zirconium dichloride,
ethylenebis-1-(4,7-dimethylindenyl)zirconium dichloride,
ethylenebis-1-indenylzirconium dichloride,
ethylenebis-1-tetrahydroindenylzirconium dichloride,
indenylcyclopentadienylzirconium dichloride
isopropylidene(1-indenyl)(cyclopentadienyl)zirconium dichloride,
isopropylidene(9-fluorenyl)(cyclopentadienyl)zirconium dichloride,
phenylmethylsilylbis-1-(2-methylindenyl)zirconium dichloride,
and also the alkyl derivatives or aryl derivatives of each of these metallocene dichlorides.

The single-center catalyst systems are activated using suitable cocatalysts. Suitable cocatalysts for metallocenes of the formula I are organoaluminum compounds, especially alumoxanes, or else aluminum-free systems such as R²⁰ₓNH₄₋ₓBR²¹₄, R²⁰ₓPH₄₋ₓBR²¹₄, R²⁰₃CBR²¹₄ or BR²¹₃. In these formulae x is a number from 1 to 4, the radicals R²⁰ are alike or different, preferably alike, and denote C₁-C₁₀ alkyl or C₆-C₁₈ aryl, or two radicals R²⁰, together with the atom connecting them, form a ring, and the radicals R²¹ are alike or different, preferably alike, and stand for C₆-C₁₈-aryl, which may be substituted by alkyl, haloalkyl or fluoro. In particular R²⁰ stands for ethyl, propyl, butyl or phenyl and R²¹ for phenyl, pentafluorophenyl, 3,5-bistrifluoromethylphenyl, mesityl, xylyl or tolyl.

Additionally in many cases a third component is required in order to maintain protection from polar catalyst poisons. Suitable such components include organoaluminum compounds such as, for example, triethylaluminum, tributylaluminum, and others, and also mixtures.

Depending on the process it is also possible for supported single-center catalysts to be used. Preference is given to catalyst systems in which the residual amounts of support material and cocatalyst do not exceed a concentration of 100 ppm in the product.

Processes for preparing such polyolefins are described for example in EP 321 851, in EP 321 852, in EP 384 264, in EP 571 882, and in EP 890 584.

The adhesive of the invention may further comprise polyolefin plastics, waxes, polar polymers such as ethylene-vinyl acetate copolymers, polyacrylates, polyesters, polyethers, polycarbonates, polyacetals, polyurethanes, polyolefins not prepared using metallocene catalysts, rubber polymers, such as nitrile copolymers or styrene/butadiene copolymers, polyisobutylene, styrene-butadiene-styrene or styrene-isoprene-styrene block copolymers, rubbers, fillers, stabilizers and/or antioxidants.

The adhesive of the invention may be presented in any conceivable form, such as sticks, blocks, figures, spheres or cones, and is outstandingly suitable for adhesively bonding paper, card, wood, glass, plastic, e.g., polyethylene, polyesters, and also metal, aluminum foil for example.

### EXAMPLES

The examples below are intended to illustrate the invention but are not such as to restrict it to these examples. All percentages are to be understood as weight percentages.

The melt viscosities were measured in accordance with DIN 53019 using a rotational viscometer.

The drop points were measured in accordance with ASTM D3954, the ring & ball softening points in accordance with ASTM D3104.

The needle penetration number (═NPN) was determined in accordance with ASTM D 1321.

The molar mass weight average M_{w} and the molar mass number average Mₙ were determined by gel permeation chromatography at a temperature of 135° C. in 1,2-dichlorobenzene.

The polyolefins 1 to 3 used in accordance with the invention, as set out in table 1, were prepared in accordance with the method specified in the documents.

EP 0 384 264 and EP 0 571 882, respectively. Polyolefin 4 was prepared from polyolefin 1 by means of peroxide-induced grafting with 3% by weight of maleic anhydride in accordance with EP 941 257, general instructions, examples 1 to 11.

TABLE 1
Polyolefins used

| | Polyolefin 1 | Polyolefin 2 | Polyolefin 3 | Polyolefin 4 |
|---|---|---|---|---|
| Prepared as per | EP 0 384 264 | EP 0 384 264 | EP 0 571 882 | EP 0 941 257 |
| | gen. instructs. | gen. instructs. | ex. 3 | gen. instructs. |
| | ex. 1-16¹⁾ | ex. 1-16²⁾ | | ex. 1-11 |
| Type | Propylene- | Propylene- | Propylene | Polyolefin 1, |
| | ethylene | ethylene | homopolymer | grafted with 3% |
| | copolymer | copolymer | | maleic |
| | | | | anhydride |
| Softening/ | 83³⁾ | 88⁴⁾ | 145³⁾ | 80³⁾ |
| drop point | | | | |
| (° C.) | | | | |
| Viscosity at | 180 | 11 500 | 101 | 240 |
| 170° C. | | | | |
| (mPa · s) | | | | |
| Mₙ | 2760 | 8250 | 1980 | 2810 |
| M_{w} | 6320 | 19 110 | 3900 | 6460 |

¹⁾Polymerization data: total ethylene used: 400 g, polymerization temperature: 75° C.
²⁾Total ethylene used: 350 g, polymerization temperature: 65° C.
³⁾Drop point
⁴⁾Softening point

TABLE 2
Example formulas (amounts in % by weight)

| | Example | | | | |
|---|---|---|---|---|---|
| | 1 | 2 | 3 | 4 | 5 |
| Polyolefin 1 | 40 | 40 | 55 | 50 | |
| Polyolefin 2 | 20 | 20 | | | 60 |
| Polyolefin 3 | | | 5 | | |
| Polyolefin 4 | | | | 10 | |
| Sukurez SU 90 | 40 | | 40 | | |
| Foral AX-E | | 40 | | 40 | 35 |
| Plasticizer*) | | | | | 5 |
| Softening point (° C.) | 77 | 77 | 121 | 124 | 75 |
| NPN (×0.1 mm) | 20 | 25 | 20 | 17 | 31 |

*)amorphous copolymer of propylene and ethylene, prepared on the lines of EP 0 200 351, p. 13, tab. 2, example 5, visc./170° C. = 320 mPa · s.
Sukurez SU 90: hydrocarbon resin from Kolon Chemical Company;
Foral AX-E: hydrocarbon resin from Eastman Chemical Company

The raw materials listed in table 2 were melted in the proportions indicated and were mixed at a temperature of 180° C. The melt mixtures were poured into a cylindrical silicone mold having an internal diameter of 2 cm and a length of 5 cm. After cooling, the solid stick was removed from the mold.

By means of rubbing under gentle pressure, linear adhesive films were produced on copier paper, on household aluminum foil, and on an LDPE sheet. By pressing a counterpart sheet onto the adhesive film, stable bonds were produced between all conceivable combinations of paper, aluminum, LDPE, and polyester.

1. A dimensionally stable adhesive which can be applied at room or ambient temperature to a surface of a substrate, comprising at least one polyolefin prepared in the presence of a metallocene catalyst, wherein the at least one polyolefin has a ring & ball softening point in the range from 50 to 165° C., a needle penetration number of <50×0.1 mm, and a melt viscosity, measured at a temperature of 170° C., in the range from 20 to 40 000 mPa·s.

2. The dimensionally stable adhesive as claimed in claim 1, wherein the adhesive is water- and solvent-free.

3. The dimensionally stable adhesive as claimed in claim 1, wherein the at least one polyolefin has a drop point or ring & ball softening point in the range from 60 to 165° C.

4. The dimensionally stable adhesive as claimed in claim 1, wherein the at least one polyolefin has a number-average molar mass Mₙ in the range from 500 to 20 000 g/mol, and a weight-average molar mass M_{w} in the range from 1000 to 40 000 g/mol.

5. The dimensionally stable adhesive as claimed in claim 1, wherein the at least one polyolefin is a homopolymer of linear or branched 1-olefins having 3 to 20 carbon atoms or are olefin copolymers comprising linear or branched 1-olefins having 3 to 20 carbon atoms and, optionally, ethylene.

6. The dimensionally stable adhesive as claimed in claim 1, wherein the wherein the at least one polyolefin is a propylene homopolymer or copolymer of propylene with one or more further monomers selected from the group consisting of ethylene and linear or branched 1-olefins having 4 to 20 carbon atoms, the amount of structural units originating from polypropylene in the case of the copolymers being between 70% and 99.9%.

7. The dimensionally stable adhesive as claimed in claim 1, further comprising one or more polar-modified olefin homopolymers, copolymers or a mixture thereof.

8. The dimensionally stable adhesive as claimed in claim 1, wherein the amount of the at least one polyolefin is in the range from 2% to 100% by weight.

9. The dimensionally stable adhesive as claimed in claim 1, further comprising one or more resins in an amount in the range from 0% to 60%.

10. The dimensionally stable adhesive as claimed in one claim 1, further comprising one or more plasticizers.

11. The dimensionally stable adhesive as claimed in claim 1, further comprising an additional, a polar or polar, polyolefin, wax, colorant, filler, stabilizer, antioxidant or a mixture thereof.

12. A glue product comprising the dimensionally stable adhesive as claimed in claim 1.

13. The dimensionally stable adhesive as claimed in claim 1, wherein the melt viscosity, measured at a temperature of 170° C., of the at least one polyolefin is from 50 to 30 000 mPa·s.

14. The dimensionally stable adhesive as claimed in claim 1, wherein the melt viscosity, measured at a temperature of 170° C., of the at least one polyolefin is from 10 to 20 000 mPa·s.

15. The dimensionally stable adhesive as claimed in claim 1, wherein the at least one polyolefin has a drop point or ring & ball softening point in the range from 70 to 150° C.

16. The dimensionally stable adhesive as claimed in claim 1, wherein the at least one polyolefin has a drop point or ring & ball softening point in the range from 80 to 140° C.

17. The dimensionally stable adhesive as claimed in claim 1, wherein the at least one polyolefin has a number-average molar mass Mₙ in the range from 800 to 10 000 g/mol, and a weight-average molar mass M_{w} in the range from 1600 to 30 000 g/mol.

18. The dimensionally stable adhesive as claimed in claim 6, wherein the the amount of structural units originating from polypropylene in the case of copolymers being between 80% and 99% by weight.

19. The dimensionally stable adhesive as claimed in claim 1, wherein the amount of the at least one polyolefin is in the range from 30% to 90% by weight.

20. The dimensionally stable adhesive as claimed in claim 1, wherein the amount of the at least one polyolefin is in the range from 40% to 70% by weight.

21. The dimensionally stable adhesive as claimed in claim 1, wherein the amount of the at least one polyolefin is in the range from 50% to 60% by weight.

22. The dimensionally stable adhesive as claimed in claim 1, further comprising one or more resins in an amount in the range from from 10% to 50% by weight.

23. The dimensionally stable adhesive as claimed in claim 1, further comprising one or more resins in an amount in the range from 20% to 40% by weight.

24. The glue product as claimed in claim 12, wherein the glue product is in the form of a stick, block, figure, sphere or cone.
